(19) United States
(12) Patent Application Publication
(10) Pub. No.: US 2006/0000848 A1
(43) Pub. Date: Jan. 5, 2006

(54) Dispenser with integral display surfaces

(76) Inventor: Dallas Humphrey, Long Lake, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/112,876

(22) Filed: Apr. 22, 2005

Related U.S. Application Data
(60) Provisional application No. 60/564,635, filed on Apr. 22, 2004.

(51) Int. Cl. B65H 1/00; B65G 59/00

(52) U.S. Cl. 221/283

(57) ABSTRACT

The present invention is directed towards improved dispensers having at least one display surface that can display desired indicia to consumers. Generally, the dispenser can include one or more outside panels having printed indicia located thereon. Additionally, the dispensers can include a lens, which can provide a viewing surface for displaying written text, graphics or other indicia. In some embodiments, the lens can be formed from glass, Plexiglas or a dry erase board, while in other embodiments the lens can be a computer monitor or the like.

### CROSS-REFERENCE TO RELATED APPLICATIONS

The current application claims the benefit of priority from U.S. provisional patent application filed on Apr. 22, 2004, entitled “Dispenser With Integral Display,” having Ser. No. 60/564,635, which is incorporated herein by reference.

### FIELD OF THE INVENTION

The invention relates to dispenser devices having one or more integral display surfaces that can display indicia such as, for example, advertisements, promotions and the like. More particularly, the invention relates to dispenser devices having integral display surfaces that can be easily interchanged or altered to facilitate updating the displayed indicia.

### BACKGROUND OF THE INVENTION

Products such as candy, gum other items are often placed in vending machines or dispenser devices where they are available to persons wishing to purchase items, and are secured from being stolen or tampered with. Typically, these vending machines are kept in relatively inaccessible places in retail stores because the space occupied by the vending machines are desirable for retail sales displays and the like. Additionally, retailers often charge owners of the vending machines a rental fee for the space occupied by these devices.

There is then a need for a dispenser device that an establishment owner will be willing to place in more accessible or prominent locations within the establishment. There is also a need for a dispenser device that can provide additional sources of revenue for the owner of the dispenser device beyond revenue from products dispensed from vending machines.

### SUMMARY OF THE INVENTION

The present invention is directed towards improved dispenser devices having one or more vending machines and at least one display surface that can display desired indicia including sales related media to consumers. Generally, the dispenser device will have a base portion, a top portion, and a vending machine receiving portion between the base portion and the top portion. Outside facing surfaces of the dispensing device may include front and side panels on the bottom portion, side panels on vending machine receiving portion as well as a facia, back and side panels of the top portion. The dispenser can include one or more display surfaces on the outside facing surfaces of the dispenser device having printed indicia located thereon.

Additionally, the dispenser devices can include a lens portion attached to the back panel above the one or more vending machines, which can provide a viewing surface for displaying written text, graphics or other indicia. In some embodiments, the lens can be formed from glass, Plexiglas or a dry erase board. Alternately, the dispenser device can include a screen which can be an active display such as a computer monitor or the like.

Due to the presence of the lens or screen and the one or more display surfaces, the improved dispenser devices can display indicia such as graphics, which can facilitate placing the improved dispenser devices in desirable or high traffic area of a store or restaurant. In some embodiments, the dispenser devices can include a light source, which can illuminate the lens, or other desired surfaces of the dispenser device, such that the indicia including graphics and/or text can be easily viewed by an observer. In some embodiments, the panels of the dispenser device having outside facing surfaces including, for example, the side panels, the front panels and the facia, or the display surfaces themselves can be interchangeable, thereby facilitating rotation or updating of the indicia displayed on the dispenser device.

The dispenser devices of the present disclosure provide display surfaces for showing indicia such as, for example, advertising or promotions for a retail store or restaurant. Some of the display surfaces, such as the outside facing surfaces of the facia, front, left and right panels, may display advertising thereon which is reasonably permanent and may not be easily changed. However, one or more of the display surfaces may display indicia that can be easily changed as desired. For example, the indicia can be easily changed by printing the indicia on interchangeable panels, writing the indicia on a rewritable surface such as glass or Plexiglas, displaying the indicia on a computer screen, television monitor or the like, or combinations thereof. These display surfaces are desirable because they have a more pleasing appearance and may become a source of advertising revenue. In addition, these display surfaces are also desirable because they provide a surface on which noticeable and easily changeable indicia can be displayed to provide customer related information such as promotions and/or advertisements.

A portion, or all, of the panels of the dispenser devices having an outside facing surface can be interchangeable panels, which facilitates replacing one panel(s) with another panel(s) having different indicia printed thereon. In some embodiments, the panels of the dispenser devices having an outside facing surface can include magnetic portions, which allows the display surfaces to be removeably secured such that the display surfaces can be easily applied and removed from the dispenser device. Materials having a magnetized surface and a non-magnetized surface are described in, for example U.S. Pat. No. 6,436,520, entitled “Magnetic Display Device,” the disclosure of which is hereby incorporated by reference herein. In other embodiments, the panels of the dispenser devices having an outside facing surface can be removeably secured to the dispenser device by, for example, adhesives, set screws, pins and combinations thereof. In further embodiments, the corners and/or periphery portions of the dispenser device can be provided with clip-like engagement members that can secure and hold the display surfaces in desired orientations.

The dispenser devices of the present disclosure can include a plurality of sections that can be operably coupled to form the dispenser device. In one embodiment, the dispenser device can include a first section defining an interior storage region, a second section above the first section having an opening adapted to receive at least one vending machine or dispensing apparatus and a third section above the second section having a lens or screen. In some embodiments, the first, second and third sections can be distinct assemblies that are combined to form the final dispenser device, while in other embodiments, the first and third sections can be distinct sections that can be operably coupled to form and define the second section.

In a first aspect, the invention pertains to a dispenser device including a first portion having first and second side panels, a top panel, a back panel, a facia portion and a lens or screen operably coupled to the first and second side panels and a second portion having an opening adapted to receive at least one vending machine. In these embodiments, the dispenser device can further include a third portion having a front panel, a back panel, first and second side panels and a base panel operably coupled to define an interior space, wherein the front panel is hingedly coupled to the first side panel such that the front panel can be moved from an open position to a closed position. In these embodiments, at least one vending machine can be positioned within the opening of the second portion, the vending machine having a product storage container operably coupled to a dispenser mechanism.

In a second aspect, the invention pertains to a method of dispensing a product including the step of providing a dispenser device comprising a first portion having a lens or screen and a second portion having at least one vending machine, the vending machine having a product storage container operably coupled to a dispenser mechanism. In these embodiments, the method can further include the step of removeably securing a panel to the dispenser, the panel having indicia printed on at least one surface of the panel.

It is one feature of the present dispenser to provide display surfaces on which indicia are present. The indicia can include, for example, text, graphics, logos, trademarks, advertisements, promotional literature, and combinations thereof.

It is another feature of the present dispenser to provide at least one display surface in which indicia can be changed as desired.

It is still another feature of the present dispenser that the display surface on which indicia can be changed as desired, and can be illuminated.

It is an advantage of the foregoing features that advertising can be present on the display surfaces.

It is another advantage of the foregoing features that the device will be more attractive to retailers, thereby the device will be more likely to occupy desirable retail space.

It is still another advantage of the foregoing features that the indicia can be a source of advertising income to retailers and owners of the present device.

It is yet still another advantage of the foregoing features that retailers can display information that can be changed as desired.

It is yet still another advantage of the foregoing features that the changeable information displayed is readily noticeable to customers.

### BRIEF DESCRIPTION OF THE FIGURES

FIG. 1 is a front view of one embodiment of a dispenser with an integral display of this invention.

FIG. 2 is a side view of the embodiment of FIG. 1.

FIG. 3 is a perspective view of the embodiment of FIG. 1 showing one type of indicia present on the outside surfaces thereof and depicting erasable indicia present on a lens.

FIG. 4 is a perspective view of the embodiment of FIG. 1 showing another type of indicia present on the outside surfaces thereof and displaying nonerasable indicia from behind the lens.

FIG. 5 is a perspective view of the embodiment of FIG. 1 showing yet another type of indicia present on the outside surfaces thereof and displaying erasable indicia present on the lens.

FIG. 6 is a front view of another embodiment of a bulk dispenser with integral display having six vending machines.

FIG. 7 is a side view of the dispenser of FIG. 6.

### DETAILED DESCRIPTION OF THE INVENTION

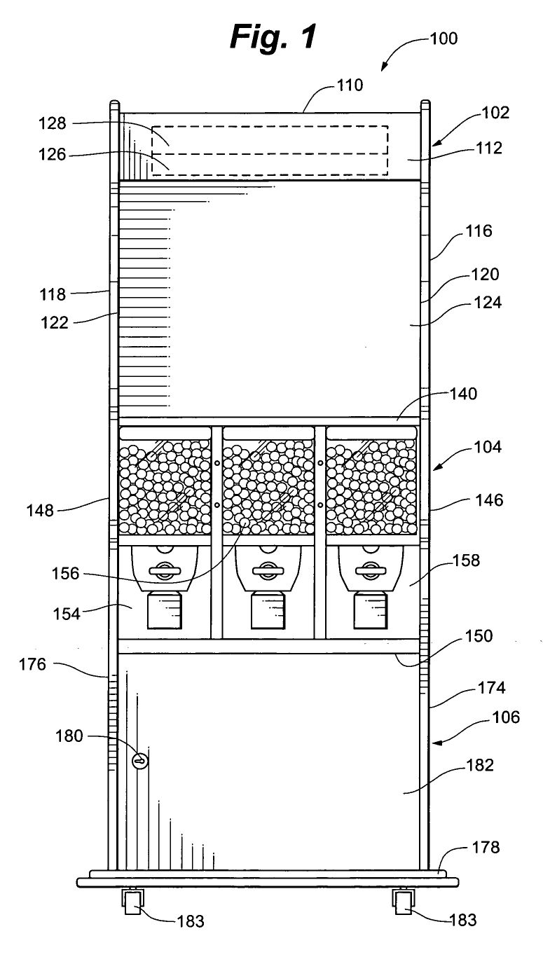

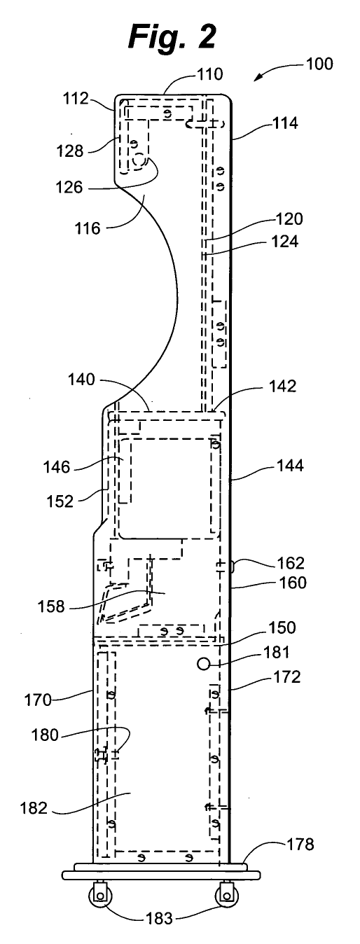

An embodiment of a dispenser having integral display surfaces is depicted in FIGS. 1-3 at 100, and can include a first portion 102, a second portion 104, and a third portion 106. As described above, first portion 102, second portion 104 and third portion 106 can be distinct portions that are combined to form dispenser 100. Alternatively, first section 102 and third section 106 can be distinct sections that can be operably coupled to form and define second section 104.

First portion 102 can include a top 110 panel, a facia 112, a back panel 114, first side panel 116, and second side panel 118. In embodiments where first portion 102 and third portion 106 can be operably coupled to define and form second section 104, first section 102 can further include a bottom panel. The first and second side panels 116, 118 can each define a generally axial slot 120 and 122, respectively, which can slidably accommodate lens 124. In some embodiments, lens 124 may be made from materials, such as glass, Plexiglas or a dry erase board, which can erasably retain markings from, for example, fluorescent markers. In these embodiments, indicia can be applied to the lens using a suitable marker, and can be updated and changed as desired. In other embodiments, a screen such as, for example, a computer monitor, liquid crystal display (LCD), light-emitting diode (LED) display, television or the like, which facilitates displaying animated indicia, including text and/or graphics, on dispenser 100 may be included in place of the lens.

One or more light sources 126 can be provided on the interior and/or exterior surfaces of dispenser 100 to illuminate desired surfaces of dispenser 100. Light source 126 can be, for example, a black light, a fluorescent light, an incandescent light, a floodlight or combinations thereof. In one embodiment, light source 126 can be a 10-20 Watt black light powered by a 120 Volt outlet. In some embodiments, light source 126 may be operably mounted to an inner surface of first portion 102 such as, for example, an inner surface facia 112, to illuminate lens 124. Additionally or alternatively, one or more light sources can be positioned to illuminate the outside surfaces of side panels 116, 118 and/or facia 112. It is to be appreciated that light source 126 may be of any suitable wattage, and the wattage of the light source(s), as well as the number of light sources, employed in a particular embodiment can be guided by the size of the desired illuminated area and the degree to which the desired indicia are to be illuminated.

As described above, second portion 104 can include an opening or recess adapted to receive at least one vending machine or dispenser. In some embodiments, second portion 104 can include respective first and second top panels 140 and 142, a back panel 144 (which is optionally integral with the back panel 114), respective first and second side panels 146 and 148 (also optionally integral with first and second side panels 116, 118), and a bottom panel 150 to define an opening 152. In other embodiments, second portion 104, and opening 152, can be formed and defined by operably coupling first portion 102 and third portion 106. At least one device, such as vending machines 154, 156 and 158, may be securably disposed in second portion 104 such that the devices are viewable via the opening 152. Although FIGS. 1-3 depict and embodiment having three vending machines disposed in second section 104, embodiments are contemplated having 1,2, and 4-6 vending machines disposed within second section 104. In some embodiments, back panel 144 can include an opening covered by hinged door 160 and secured by lock 162. In these embodiments, door 160 can be opened to provide access to, for example, the cash boxes of vending machines 154, 156, and 158.

Third portion 106 can include a front panel 170, a back panel 172 (which is optionally integral with the back panels 144 and 114), respective first and second side panels 174 and 176 (also optionally integral with the left and right panels 146 and 148 and 116 and 118), and a base 178. In embodiments where first section 102 and third section 106 can be operably coupled to form and define second section 102, third portion 106 can further include a top panel. In the embodiment depicted, front panel 170 is hinged to first side panel 174 and is secured by lock 180. Panels 170, 172, 174, and 176, and base 178 can be operably coupled to define a storage area 182, which can be used to store, for example, additional product for refilling vending machines 154, 156, 158 disposed in second section 104. In some embodiments, one or more of the panels that form third section 106 can comprise a vent 181 to facilitate airflow into and out of storage area 182. In some embodiments, base 178 can include a plurality of casters 183, which facilitates moving dispenser 100 to different locations within a store or restaurant. In some embodiments, casters 183 can include a locking mechanism to reduce movement of dispenser 100 once dispenser 100 has been positioned in a desired location. Suitable casters are sold by, for example, Algood Casters Limited (Toronto, Ontario).

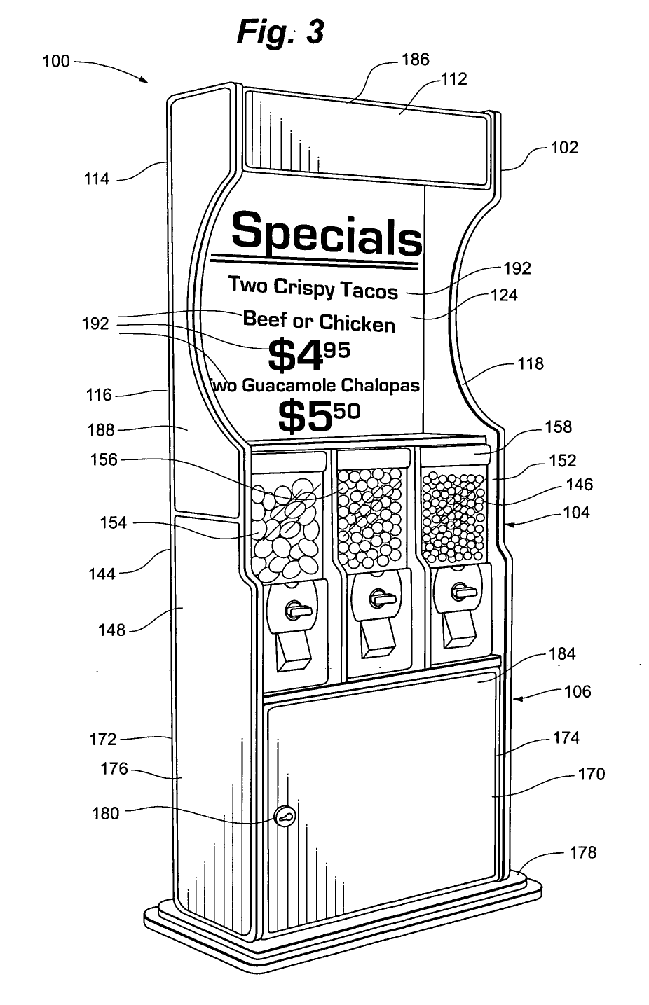

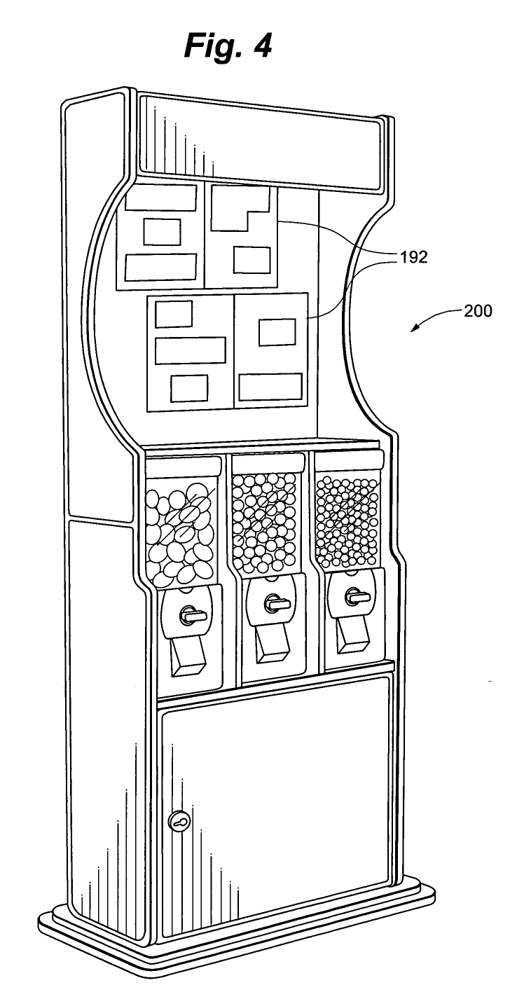

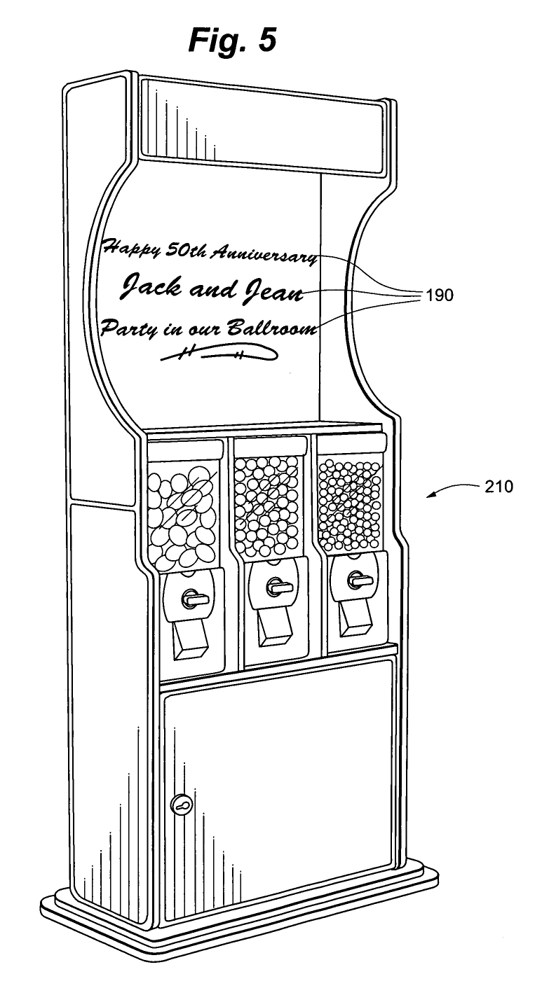

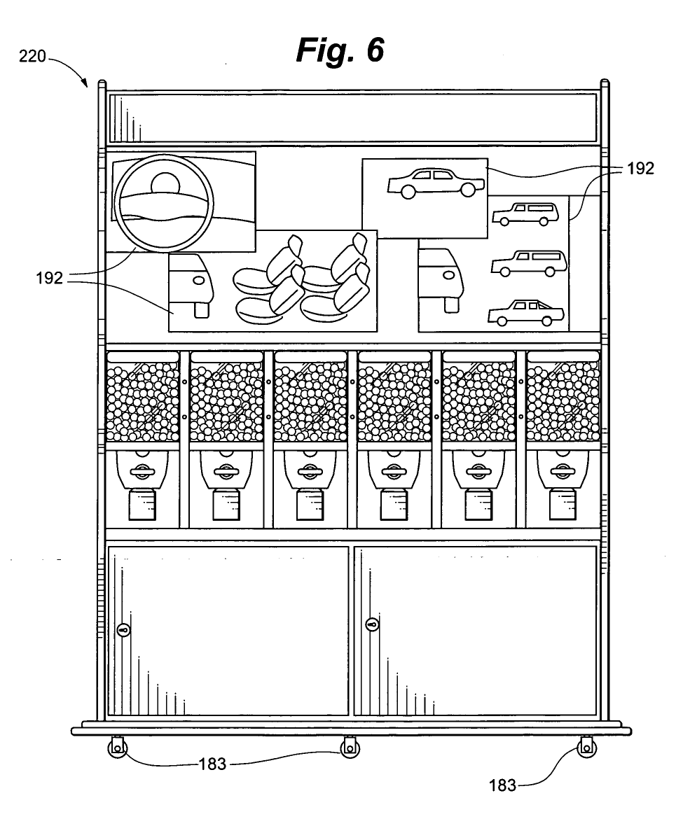

Referring to FIGS. 3-7, each of the instant facia, front, side panels may include indicia as indicated at 184, 186, and 188 displayed thereon. The indicia 184, 186, and 188 may be imprinted directly on the surfaces of these elements. Alternatively, the indicia may be printed on separate panels or the like and held in place on the surfaces by adhesives, magnets, pins, set screw, clips or the like. In other embodiments, the separate panels printed with indicia thereon may be held in place between the instant facia, front, and side panels and by a clear outer materials such as Plexiglas or the like. As more fully explained below, indicia as indicated at 190 in FIGS. 3 and 5 may be removably placed on lens 124. In addition, indicia, such as indicated at 192 in FIGS. 4 and 6, may be displayed behind lens 124. The indicia 130 may be printed on separate panels held in place between the lens 124 and the back 114.

In use, one or more vending machines can be disposed and optionally secured in the second portion 104 of the instant dispenser so that the front of the vending machines is visible and accessible to purchasers. The purchasers may purchase items by depositing money in the vending machines and receiving products therefrom. Items, such as additional products to be dispensed by the vending machines, markers, erasers and cleaning products, may be stored in the storage area 182 until needed for use. Additionally, further indicia may be placed on lens 124 in the manner depicted in FIG. 3 and indicated at 190. The indicia 190, in the embodiment shown, displays information that can be changed as desired, for example, a menu changing daily. If a black light is present, and the indicia are written with a fluorescent marker, the indicia are emphasized and more easily noticed by potential customers. The information presented by the indicia can be changed as desired by erasing the markings and scripting updated information such as, for example, a new daily menu, sale or other promotion. The embodiments shown in FIGS. 4 and 5 at 200 and 210, respectively, illustrates different information that can be displayed on lens 124. As depicted in FIG. 4, indicia 192 can include a advertising circular, or other promotion literature, operably coupled to an inside surface of lens 124 such that the advertising circular is visible through lens 124.

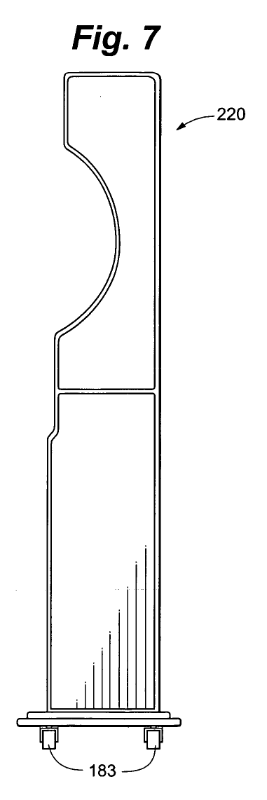

Referring to FIGS. 6 and 7, dispenser and display 220 is shown to demonstrate an embodiment with a plurality (e.g., six) of vending machines. One of ordinary skill in the art will recognize that the dimensions of the instant dispenser and display are variable in response to such factors as available space to accommodate the device and available space for the indicia.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

What is claimed is:

1. A retail presentation system integrating one or more vending machines and structure for presenting sales related media to an observer into a visually unified display unit having a common footprint, comprising:
a base portion, the base portion comprising a front panel, a back panel, two side panels, a bottom panel and a top panel, the front and side panels of the base portion comprising display surfaces, the display surfaces further comprising indicia apparent to the observer;
a vending machine receiving portion disposed above the base portion, comprising a back panel and capable of receiving one or more vending machines therein at a height that is convenient to a user of the one or more vending machines disposed therein;
a top portion, disposed above the vending machine receiving portion, the top portion comprising a top panel, two side panels, a facia connected to the top panel and the side panels, and a back panel, the side panels of the top portion and the facia comprising display surfaces, the display surfaces further comprising indicia apparent to the observer;
a lens connected to the back panel in the top portion capable of displaying indicia and apparent to the observer; and
at least one vending machine disposed within the vending machine receiving portion.

2. The retail presentation system of claim 1, wherein the lens comprises one or more indicia.

3. The retail presentation system of claim 1, wherein the vending machine receiving portion further comprises side panels, the side panels of the vending machine receiving portion comprising display surfaces, the display surfaces further comprising indicia apparent to the observer.

4. The retail presentation system of claim 3, wherein the side panels of the base portion, the side panels of the vending machine receiving portion and the side panels of the top portion on each side are integral with the other side panels on the same side, and wherein the display surfaces of the integral side panels are integral with the other display surfaces on the same side.

5. The retail presentation system of claim 2, wherein at least one of the indicia comprises sales related media selected from the group consisting of advertising or promotions.

6. The retail presentation system of claim 2, wherein the display surfaces are removable and interchangeable with display surfaces comprising different indicia thereby allowing the indicia to be changed or rotated.

7. The retail presentation system of claim 1, wherein the front panel of the base portion further comprises a door allowing access to an interior space defined by the panels of the base portion.

8. The retail presentation system of claim 1, wherein a light source is disposed within the top portion between the facia and the lens.

9. The retail presentation system of claim 1, wherein at least one of the side panels of the top portion defines a slot through which the lens may be slidably accommodated.

10. A retail presentation system integrating one or more vending machines and structure for presenting sales related media to an observer into a visually unified display unit having a common footprint, comprising:
a base portion, the base portion comprising a front panel, a back panel, two side panels, a bottom panel and a top panel, the front and side panels of the base portion comprising display surfaces, the display surfaces further comprising indicia apparent to the observer;
a vending machine receiving portion disposed above the base portion, comprising a back panel and capable of receiving one or more vending machines therein at a height that is convenient to a user of the one or more vending machines disposed therein;
a top portion, disposed above the vending machine receiving portion, the top portion comprising a top panel, two side panels, a facia connected to the top panel and the side panels, and a back panel, the side panels of the top portion and the facia comprising display surfaces, the display surfaces further comprising indicia apparent to the observer;
a screen for active display of indicia connected to the back panel in the top portion and apparent to the observer; and
at least one vending machine disposed within the vending machine receiving portion.

11. The retail presentation system of claim 10, wherein the screen is an active display selected from the group consisting of a computer monitor, a LCD screen, a LED screen, a television monitor and combinations thereof.

12. The retail presentation system of claim 10, wherein the vending machine receiving portion further comprises side panels, the side panels of the vending machine receiving portion comprising display surfaces, the display surfaces further comprising indicia apparent to the observer.

13. The retail presentation system of claim 12, wherein the side panels of the base portion, the side panels of the vending machine receiving portion and the side panels of the top portion are integral with the other side panels on the same side, and wherein the display surfaces of the integral side panels are integral with the other display surfaces on the same side

14. The retail presentation system of claim 11, wherein at least one of the indicia comprises sales related media selected from the group consisting of advertising or promotions.

15. The retail presentation system of claim 1 1, wherein the display surfaces are removable and interchangeable with display surfaces comprising different indicia thereby allowing the indicia to be changed or rotated.

16. The retail presentation system of claim 11, wherein the front panel of the base portion further comprises a door allowing access to an interior space defined by the panels of the base portion.
